(19) United States
(12) Patent Application Publication
(10) Pub. No.: US 2024/0262231 A1
(43) Pub. Date: Aug. 8, 2024

(54) POWER SUPPLY SYSTEM USING A FLYING BODY

(71) Applicant: AISAN KOGYO KABUSHIKI KAISHA, Obu-shi (JP)

(72) Inventors: Arashi KOYANAGI, Kariya-shi (JP); Minoru AKITA, Ama-shi (JP); Noriaki TERASAWA, Tokai-shi (JP); Tomoki MAEDA, Obu-shi (JP); Masanobu OHMI, Kasugai-shi (JP); Masanobu KONDO, Nagoya-shi (JP); Hiroyuki SHIMIZU, Nagoya-shi (JP)

(73) Assignee: AISAN KOGYO KABUSHIKI KAISHA, Obu-shi (JP)

(21) Appl. No.: 18/416,452

(22) Filed: Jan. 18, 2024

(30) Foreign Application Priority Data
Feb. 6, 2023 (JP) 2023-016232

(51) Int. Cl. B60L 53/57; B60L 53/62; B60L 53/68; B64U 50/33; B64U 101/10

(52) U.S. Cl. CPC B60L 53/57; B60L 53/62; B60L 53/68; B64U 50/33; B64U 2101/10

(57) ABSTRACT

A power supply system includes: a drone including a propeller, a motor for driving the propeller, a power control unit for supplying the motor, a battery storing electric power, a generator for generating the power, an engine for driving the generator, a fuel tank storing fuel to be supplied to the engine, and a power suppling device for supplying the power generated by the generator to a power supply target; a control unit for controlling various operations of the drone; and an operation management unit for controlling the operations of the drone. Upon receipt of a power supply request, the operation management unit flies the drone to the location of the target. After the drone arrives at the target, the control unit causes the generator to generate the power based on a command from the operation management unit to supply the power to the target via the power suppling device.

### CROSS-REFERENCE TO RELATED APPLICATIONS

This application is based upon and claims the benefit of priority to Japanese Patent Application No. 2023-016232 filed on Feb. 6, 2023, the entire contents of which are incorporated herein by reference.

### BACKGROUND

### Technical field

The disclosure relates to a power supply system for supplying electric power to a power supply target by use of a flying body.

### Related Art

One example of the power supply system for supplying electric power to a power supply target is disclosed in Japanese unexamined patent application publication No. 2020-137331. This power supply system includes a drone, which is an unmanned flying body, and an unmanned power supply vehicle for supplying electric power to a battery of the drone. The unmanned power supply vehicle is provided with a directional power supplying antenna that transmits microwaves. The drone is provided with a power receiving antenna that receives the microwaves. This configuration can feed electric power from the unmanned power supply vehicle to the battery of the drone.

### SUMMARY

### Technical Problems

However, in the above-mentioned power supply system, a power supply source is a vehicle and thus its arrival time to a power supply target varies depending on traffic situations or conditions. For example, in case of traffic congestion, it may take very long for the power supply source to arrive at a power supply target. Further, in case of disasters, roads may be severed or divided, making it impossible for the power supply source to reach a power supply target. Thus, the aforementioned power supply system may not efficiently supply electric power to a power supply target.

The present disclosure has been made to address the above problems and has a purpose to provide a power supply system using a flying body, capable of efficiently supplying electric power to a power supply target.

### Means of Solving the Problems

To achieve the above-mentioned purpose, one aspect of the present disclosure provides a power supply system comprising: a flying body including: a propeller; a propeller driving motor to drive the propeller; a power control circuit to supply electric power to the propeller driving motor; a battery to store the electric power; a power generator to generate the electric power; an engine to drive the power generator; a fuel tank to store fuel to be supplied to the engine; and a power suppling device to supply the electric power generated by the power generator to a power supply target to be supplied with the electric power; a control unit to control various operations of the flying body; and an operation management unit to manage flight operations of the flying body, the operation management unit being configured to fly the flying body to a location of the power supply target upon receipt of a request for power supply, and the control unit being configured to, after the flying body arrives at the location, generate the electric power by the power generator and supply the generated electric power to the power supply target via the power suppling device based on a command from the operation management unit.

This power supply system using the flying body provided with a power generator serving as a power supply source is configured to fly this flying body to the location of the power supply target, and the power generator to generate electric power to supply the electric power to the power supply target via the power suppling device. Therefore, the flying body serving as the power supply source can quickly arrive at the power supply target without being affected by traffic situations or road conditions. This system can therefore efficiently supply the electric power to the power supply target.

According to the present disclosure, it is possible to provide a power supply system using a flying body that can efficiently supply electric power to a power supply target.

### BRIEF DESCRIPTION OF THE DRAWINGS

FIG. 1 is a configuration diagram of a search support system using a drone in an embodiment;

FIG. 2 is an external perspective view of the drone;

FIG. 3 is a block diagram showing the configuration of the drone;

FIG. 4 is a diagram illustrating a drone flying from an operation management unit to a location of an electric vehicle;

FIG. 5 is a diagram showing the drone supplying electric power to the electric vehicle; and

FIG. 6 is a flowchart showing the contents of power supply control to be executed in a power suppling device.

### DETAILED DESCRIPTION OF THE EXEMPLARY EMBODIMENTS

A detailed description of a power supply system in an embodiment of this disclosure will now be given referring to the accompanying drawings. In this embodiment, the power supply system uses a hybrid drone as a flying body, which is provided with a battery and an engine, and this hybrid drone is used as a power supply source for a target to be supplied with electric power (hereinafter, simply referred to as a power supply target).

### Configuration of Power supply system

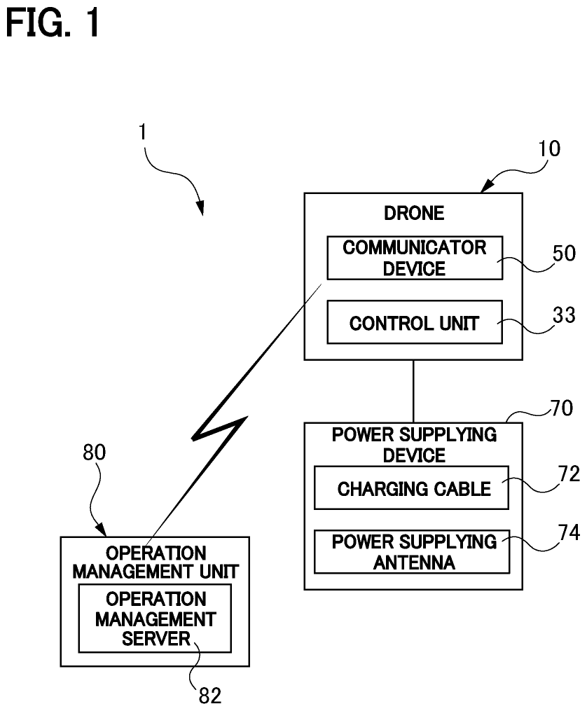

The configuration of a power supply system 1 in this embodiment will be described below referring to FIGS. 1 to 3. The power supply system 1 in the embodiment includes, as shown in FIG. 1, a drone 10, a control unit 33, a power suppling device 70, and an operation management unit 80. The control unit 33 and the power suppling device 70 are both provided in the drone 10. Further, the drone 10 is equipped with a communicator device 50, through which the drone 10 and the operation management unit 80 mutually send and receive information, so that the drone 10 is controlled by commands from the operation management unit 80. The drone 10 can also be operated by a controller not illustrated.

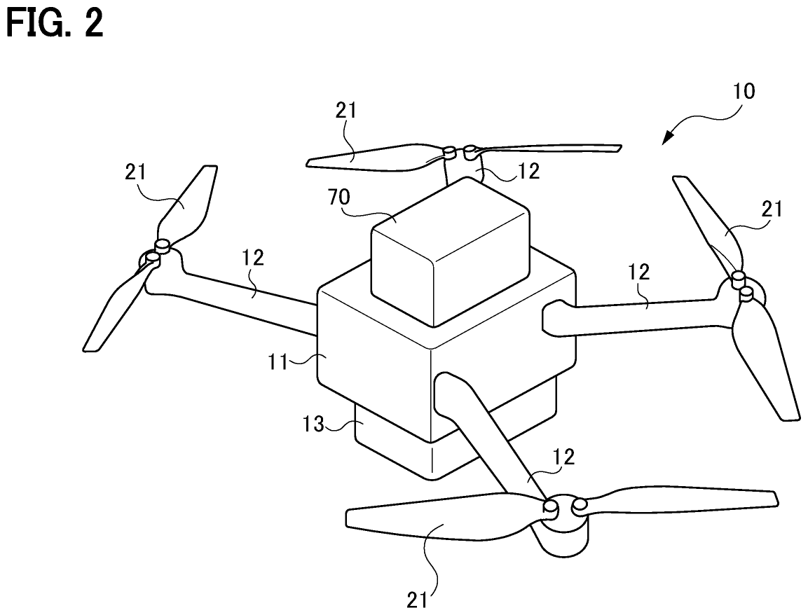

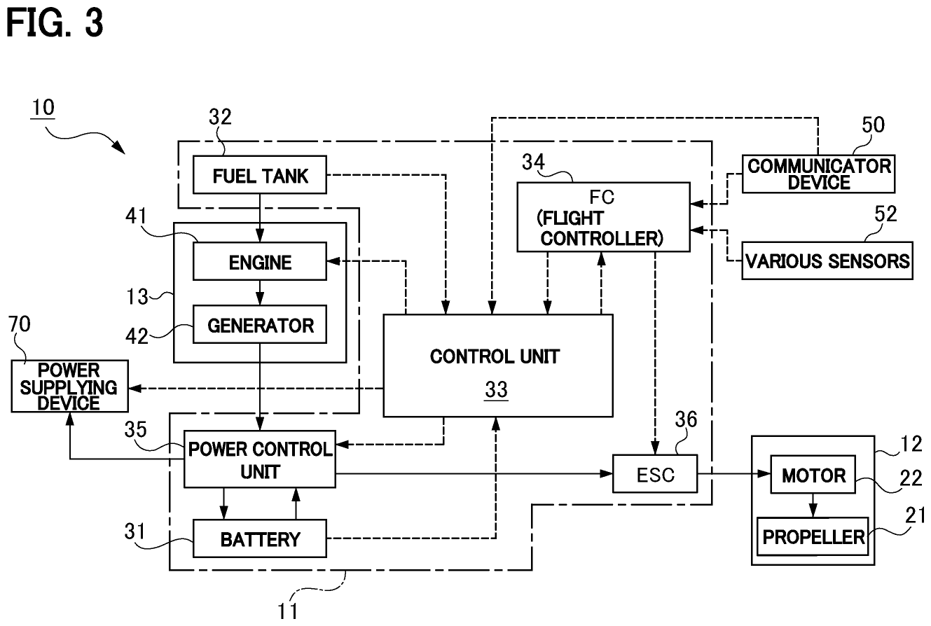

The drone 10 is an unmanned aerial vehicle, and one example of the flying body of the disclosure. The drone 10 includes, as shown in FIGS. 2 and 3, an airframe body part 11 provided with various devices, propeller parts 12 arranged radially from the airframe body part 11, an engine generator unit 13, and the power suppling device 70.

The propeller parts 12 each include a propeller 21 and a motor 22 as shown in FIG. 3, and thus the drone 10 is provided with a plurality of the propellers 21. The drone 10 flies by simultaneously rotating those propellers 21. The motors 22, i.e., motors for driving propellers, are provided one for each of the propellers 21 to rotate the corresponding propeller 21.

The motors 22 are electrically connected to a battery 31 provided in the airframe body part 11 and a generator 42 provided in the engine generator unit 13 via an electric speed controller (ESC) 36, i.e., an invertor (not shown), and a power control unit 35, each provided in the airframe body part 11. Accordingly, the electric power generated by the generator 42 and the electric power discharged from the battery 31 are supplied to the motors 22 via the power control unit 35 and the ESC 36. The generator 42 is also electrically connected to the power suppling device 70 via the power control unit 35. This configuration can supply or feed the electric power generated by the generator 42 to a power supply target via the power suppling device 70.

The airframe body part 11 is provided, as shown in FIG. 3, with the battery 31, a fuel tank 32, the control unit 33, a flight controller (FC) 34, the power control unit 35, the ESC 36, and so on.

The battery 31 is a charge/discharge unit that can charge and discharge electric power, such as a secondary battery and a storage battery. This battery 31 is electrically connected to the generator 42 via the power control unit 35 and is charged with the electric power generated by the generator 42. Furthermore, the battery 31 is electrically connected to the motors 22 via the power control unit 35 and the ESC 36 and discharges the electric power to be supplied to the motors 22. The battery 31 is provided with sensors for detecting the current and the voltage of the battery 31, and the temperature and the stage of charge (SOC) of the battery 31. Those sensors transmit signals representing the detected information to the control unit 33.

The fuel tank 32 stores fuel, e.g., gasoline, to be used for driving an engine 41 provided in the engine generator unit 13. Further, a level sensor not shown, provided in the fuel tank 32, transmits a signal representing the amount of remaining fuel to the control unit 33.

The control unit 33 is configured as a compact computer to control the entire drone 10. For example, the control unit 33 controls driving of the engine 41 to control power generation of the generator 42. The control unit 33 also controls the power suppling device 70 to supply the electric power to a power supply target.

The FC 34 is a device configured to control the flight of the drone 10. This FC 34 transmits propulsion command signals to the control unit 33 and the ESC 36, while receiving the signals representing the information on the SOC from the control unit 33. The FC 34 receives signals from the operation management unit 80 via the communicator device 50, and further receives signals representing the data on detection results from various sensors 52 mentioned below.

The power control unit 35 is a device configured to control the electric power to be supplied to the motors 22 and the electric power to be supplied to the power suppling device 70. This power control unit 35 receives the electric power generated by the generator 42, and during flight of the drone 10, supply and receive the electric power to and from the battery 31 and supply the electric power to the ESC 36, and further supply the electric power to the power suppling device 70 during power supply to the power supply target. The power control unit 35 receives command signals for switching between charge and discharge and command signals for power supply from the control unit 33. The power control unit 35 is one example of the power control circuit of the disclosure.

The ESC 36 is a device configured to control the number of revolutions of the motors 22. This ESC 36 supplies the electric power fed from the power control unit 35 to the motors 22 as the electric power for driving the motors 22. The ESC 36 also receives propulsion command signals from the FC 34.

The engine generator unit 13 includes the engine 41 and the generator 42, which is a power generator. The engine 41 is a power source for the generator 42 and is, for example, a compact diesel engine or reciprocating engine. Specifically, the engine 41 is activated at the time of causing the generator 42 to generate the electric power to be supplied to the motors 22 or the control unit 33 and the electric power to be fed to the power supply target via the power suppling device 70. For this purpose, the engine 41 receives a command signal for power generation from the control unit 33. The generator 42 is one example of the power generator of the disclosure.

The power suppling device 70 is a device configured to supply the electric power generated by the generator 42 to the power supply target. This power suppling device 70 calculates the amount of electric power allowed to be supplied from the drone 10 (referred to as a suppliable power amount) to the power supply target based on the amount of remaining oil in the fuel tank 32 and the charged amount of the battery 31. The suppliable power amount calculated at that time is the amount of electric power that can be supplied to the power supply target while setting aside the amount of electric power that allows the drone 10 to fly to a predetermined return position. Thus, the drone 10 can fly to the return position after completion of power supply to the power supply target. The return position of the drone 10 may be set to, for example, a departure point, a predetermined recovery point, and so on. Since the drone 10 arrives at the return position by flying under its own power as above, the maintenance (charging, refueling, checking, etc.) of the drone 10 can be quickly performed before receipt of a next request for power supply.

For supply electric power to the power supply target, the power suppling device 70 calculates the amount of electric power required for the power supply target (simply referred to as a required power amount) based on the data on the power supply target (including data on the distance to a nearest charging point, data on the actual electricity consumption of the power supply target, etc.) transmitted from the operation management unit 80. The required power amount for the power supply target can be, for example, the amount of electric power enough for the power supply target to move to the nearest charging point. The power suppling device 70 determines whether or not the drone 10 can feed the required power amount to the power supply target by comparing the amount of the electric power that can be supplied from the drone 10 to the power supply target and the amount of electric power required for the power supply target.

Furthermore, as shown in FIG. 1, the power suppling device 70 is provided with a charging cable 72 connected to the power supply target and further a power supplying antenna 74 that supplies the electric power to the power supply target provided with a power receiving antenna, by a known wireless method, such as a method of transmitting and receiving microwaves. Thus, the drone 10 can supply electric power, while flying, to the power supply target if the power supply target has the power receiving antenna. This can supply the electric power to a power supply target while the power supply target is moving, without being limited in its operating range. The drone 10 can therefore perform power supply to the power supply target with enhanced efficiency.

In the drone 10 in the embodiment, the motors 22, the battery 31, and the engine 41 constitute a series hybrid system. In other words, in the system of the drone 10, the engine 41 is used only for power generation, the motors 22 are used for driving the propellers 21, and further the battery 31 is used for recovering electric power. In this way, the generator 42 is driven by the engine 41 to generate electric power, and the motors 22 are driven by the generated power to operate the propellers 21, causing the drone 10 to fly. The drone 10 is configured such that the battery 31 temporarily stores residual power generated during power generation by the generator 42 driven by the engine 41 and this stored power is used to drive the motors 22 as needed. Furthermore, the drone 10 can feed the electric power generated by the generator 42 by activation of the engine 41 to a power supply target via the power suppling device 70.

The drone 10 is provided with various sensors 52 as shown in FIG. 3. These sensors 52 are used to detect altitude, attitude, latitude, longitude, acceleration, obstacles, and so on. Detection signals from the various sensors are input to the FC 34 and simultaneously transmitted to the operation management unit 80 via the communicator device 50. Thus, the operation management unit 80 can recognize the operating conditions of the drone 10 and control the drone 10 optimally.

The drone 10 configured as above flies by supplying the electric power to the motors 22 to rotate the plurality of propellers 21 based on the command from the operation management unit 80. The flight of the drone 10 can be controlled by controlling the number of revolutions of the propellers 21, and balancing the lift force obtained by the revolutions of the propellers 21 with the gravity of the drone 10 itself. Specifically, increasing the lift force generated by the propellers 21 allows the drone 10 to fly upward or alternatively decreasing the lift force generated by the propellers 21 allows the drone to fly downward. Further, when the number of revolutions of each of the propellers 21 is adjusted to unbalance the lift force generated by the revolutions of the propellers 21, the drone 10 can be flown forward, backward, rightward, and leftward. Also, when the number of revolutions of the propellers 21 is set different between the propellers 21 that rotate oppositely, the drone 10 can be rotated or turned horizontally in flight.

The operation management unit 80 is provided with an operation management server 82 connected to the Internet line. The operation management unit 80 can therefore receive a power supply request transmitted from a mobile terminal, such as a smartphone, through the Internet via the operation management server 82. Thus, the power supply system 1 in the embodiment can easily transmit a power supply request for supplying electric power to a power supply target that needs to be recharged. This makes it possible to promote widespread use of this system.

### Power supply by Power supply system

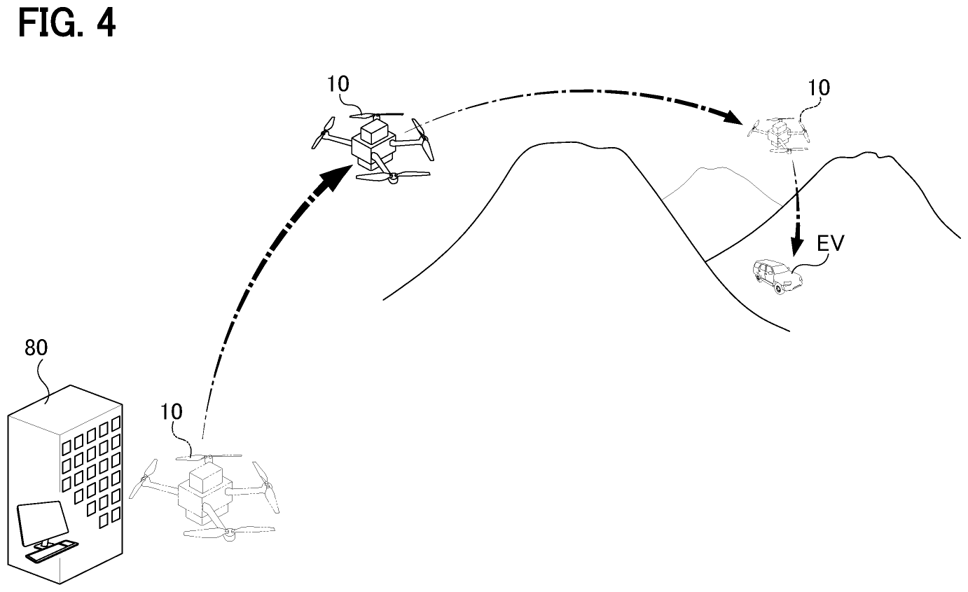

The flow of supplying electric power to a power supply target using the power supply system 1 configured as above will be described below, referring to FIGS. 4 to 6. The following description will be given by exemplifying an electric vehicle as the power supply target.

For example, assuming the situation that an electric vehicle EV becomes unable to run in a mountain area due to running out of electric power, a driver of the electric vehicle EV that runs out of electric power sends a power supply request to the operation management unit 80. This power supply request can be sent from a mobile terminal, such as a smartphone. The power supply request sent by the driver is received by the operation management server 82 of the operation management unit 80 via the Internet. At the time of receiving the power supply request, the operation management unit 80 also obtains the location information of the electric vehicle EV from the PGS information of the mobile terminal. If the GPS information cannot be obtained from the mobile terminal, the location information may be obtained by asking the driver about his/her current location. Further, the operation management unit 80 also obtains the information about the electric vehicle EV.

Upon receipt of the power supply request, the operation management unit 80 then causes the drone 10 to take off and fly to the location of the electric vehicle EV based on the obtained location information of the mobile terminal, which is substantially the same as the position information of the electric vehicle EV, as shown in FIG. 4. While the drone 10 is flying, the operation management unit 80 can ascertain the surrounding situations of the drone 10 from the images captured by a camera (not shown) installed in the drone 10. Thus, the drone 10 is allowed to fly safely and reliably to the location of the electric vehicle EV.

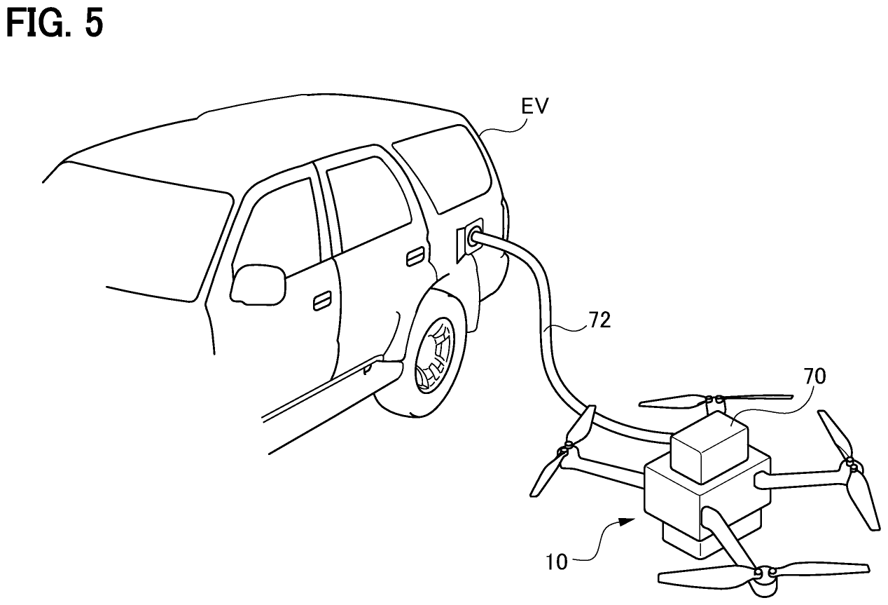

When the drone 10 arrives at the location of the electric vehicle EV, the operation management unit 80 causes the drone 10 to land at a place near the electric vehicle EV as shown in FIG. 5. At that time, the propellers 21 of the drone 10 are stopped. When the drone 10 lands thereat, the driver of the electric vehicle EV connects the charging cable 72 of the power suppling device 70 to the electric vehicle EV. The power suppling device 70 of the drone 10 is thus electrically connected to the electric vehicle EV, enabling power supply from the drone 10 to a battery of the electric vehicle EV.

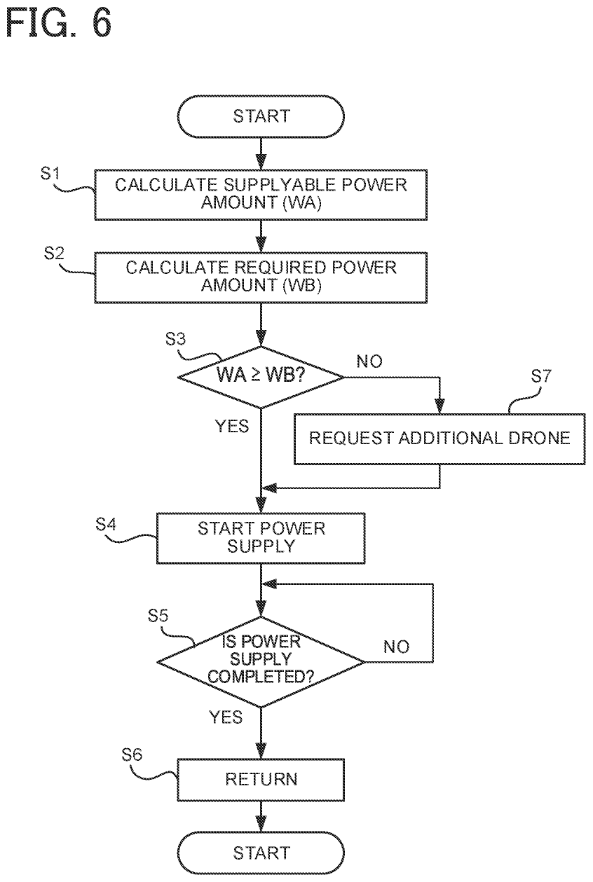

Once this power supply enabled state is confirmed, the operation management unit 80 causes the power suppling device 70 to execute power supply control. This power supply control to be executed by the power suppling device 70 will be described below with reference to a control flowchart in FIG. 6.

In step S1, the power suppling device 70 calculates the suppliable amount, which is the amount of electric power allowed to be supplied from the drone 10. Specifically, the power suppling device 70 calculates the suppliable power amount (WA) of the drone 10 based on the remaining battery level and the amount of remaining fuel in the fuel tank. The suppliable power amount (WA) calculated at that time is a value obtained by subtracting the amount of electric power allowing the drone 10 to fly to a predetermined return position (e.g., to the operation management unit 80 which is the departure point) from the maximum power that the drone 10 can currently supply. This ensures that the drone 10 flies back to the return position after completion of the power supply from the drone 10 to the electric vehicle EV.

In step S2, the power suppling device 70 calculates the required power amount (WB), which is the amount of electric power required for the electric vehicle EV to be supplied. The required power amount (WB) calculated at the time is for example the amount of electric power allowing the electric vehicle EV to run to a nearest charging point, or station. Specifically, the power suppling device 70 calculates the power amount with which the electric vehicle EV can run to the nearest charging point based on the information about electricity consumption of the electric vehicle EV and the information about the distance to the nearest charging point, which are sent from the operation management unit 80.

In step S3, the power suppling device 70 then determines whether or not the drone 10 can supply electric power to the electric vehicle EV until the required power amount is reached by comparing the suppliable power amount (WA) calculated in step S1 and the required power amount (WB) of the electric vehicle EV calculated in step S2. If the power suppling device 70 determines that electric power can be supplied to reach the required power amount (WB) (S3: YES), it starts supplying power from the drone 10 to the electric vehicle EV in step S4. Specifically, the control unit 33 drives the engine 41 to generate the electric power by the generator 42, and this generated power is supplied to the electric vehicle EV via the power control unit 35 and the power suppling device 70.

In contrast, if the power suppling device 70 determines that the drone 10 alone cannot supply electric power until the required power amount is reached (S3: NO), the power suppling device 70 sends a supplement request for additional drone or drones to the operation management unit 80 in step S7. Thereafter, the power suppling device 70 starts supplying electric power from the drone 10 to the electric vehicle EV in step S4.

Here, upon receipt of the supplement request from the power suppling device 70, the operation management unit 80 calculates the number of additional drones that can supply electric power to the electric vehicle EV to reach the required power amount. The number of additional drones is calculated based on the amount of power shortage, which is obtained as a difference between the required power amount (WB) of the electric vehicle EV and the suppliable power amount (WA) of the drone 10 (a preceding drone), and the suppliable power amount of the additional drone(s). Since the electric power amount and the gasoline amount required for the additional drone(s) to fly to the location of the electric vehicle EV and fly back to the return position can be estimated from the flight data of the drone 10, the amount of electric power that can be supplied by the additional drone(s) can be easily calculated by subtracting the above-mentioned required power amount from the original suppliable power amount before flight. Therefore, the number of the additional drone(s) that can supply electric power enough to reach the required power amount to the electric vehicle EV can be calculated very easily.

After calculating the number of additional drones, the operation management unit 80 causes the additional drone(s) by the calculated number to fly to the location of the electric vehicle EV. The additional drone or drones are identical in structure to the drone 10. Thus, when a single drone 10 alone is unable to supply electric power to the electric vehicle EV until the required power amount is reached, as many additional drones as needed to supply, or supplement, electric power up to the required power amount are flown to arrive at the location of the electric vehicle EV while the drone 10 is supplying power to the electric vehicle EV. When the drone 10 finishes supplying power to the electric vehicle EV, the additional drone or drones can continuously supply electric power to the electric vehicle EV. Accordingly, when the drone 10 alone is unable to completely charge the electric vehicle EV with the required power amount or higher, the additional drones can continuously supply electric power to the electric vehicle EV in addition to the drone 10. Thus, charging the electric vehicle EV with the required power amount or higher can be efficiently and reliably completed.

According to the power supply system 1 in the embodiment descried above, the drone 10 (and additional drones in some cases) is flown to the location of the electric vehicle EV, and then the electric power generated by the drone 10 (and additional drones in some cases) is supplied to the electric vehicle EV via the power suppling device 70. Therefore, the drone 10 serving as a power supply source can quickly arrive at the location of the electric vehicle EV without being affected by traffic situations or road conditions, thus enabling efficient power supply to the electric vehicle EV.

Thereafter, when the electric vehicle EV is completely charged with the required power amount from the drone 10 (and the additional drones in some cases) (step S5: YES), the driver of the electric vehicle EV disconnects the charging cable 72 from the electric vehicle EV and stores it in the power suppling device 70. In step S6, the operation management unit 80 then flies the drone 10 (and the additional drones in some cases) back to the return position.

At that time, the drone 10 (and the additional drones in some cases) stores enough electric power (and the remaining battery level and the remaining oil amount in the fuel tank) to fly to the return position, so that the drone 10 (and the additional drones in some cases) can surely fly under its own power to the return position. In the embodiment, the return position is set at the operation management unit 80 and thus the drone 10 (and the additional drones in some cases) that takes off from the operation management unit 80 will automatically return to the operation management unit 80 after completion of power supply. Thus, there is no need to retrieve or pick up the drone 10 (and the additional drones in some cases) that has departed for power supply, so that the drone 10 (and the additional drones in some cases) can be quickly subjected to maintenance (charging, refueling, checking, etc.) before receiving a next power supply request.

For an electric vehicle EV provided with a power receiving antenna, it is possible to supply electric power to this electric vehicle EV by transmitting and receiving microwaves between the power receiving antenna and the power supplying antenna 74 of the power suppling device 70 of the drone 10. This configuration can supply electric power from the drone 10 to the electric vehicle EV without needing connection between the power suppling device 70 and the electric vehicle EV with the charging cable 72, thus enabling efficient power supply to the electric vehicle EV.

Further, even during running of the electric vehicle EV, the wireless power supply method described as above can perform power supply from the drone 10 to the electric vehicle EV while the drone 10 is flying to follow the electric vehicle EV. Thus, it is possible to supply electric power from the drone 10 to the electric vehicle EV before the electric vehicle EV becomes unable to run.

According to the power supply system 1 in the embodiment as described above, the drone 10 provided with the engine generator unit 13 is used as the power supply source, this drone 10 is flown to the location of the electric vehicle EV that runs out of electricity, and the engine 41 and the generator 42 generate electric power to be supplied to the electric vehicle EV via the power suppling device 70. Therefore, the drone 10 can quickly arrive at the electric vehicle EV without being affected by traffic situations and road conditions, thus enabling efficient power supply to the electric vehicle EV.

The foregoing embodiments are mere examples and give no limitation to the present disclosure. The present disclosure may be embodied in other specific forms without departing from the essential characteristics thereof. For example, the foregoing embodiment exemplifies that the disclosure is applied to power supply to the electric vehicle EV that has become unable to run due to the shortage of electricity, but the disclosure is not limited thereto. The disclosure may also be applied to power supply to an electric vehicle EV that has stuck in a major traffic congestion due to, e.g., a closed road because of heavy snow.

The foregoing embodiment exemplifies the electric vehicle EV as the power supply target; however, the power supply target is not limited thereto. The disclosure is also applicable to any electrical mobile body.

### REFERENCE SIGNS LIST

1 Power supply system
10 Drone
21 Propeller
22 Motor
31 Battery
32 Fuel tank
33 Control unit
35 Power control unit
41 Engine
42 Generator
70 Power suppling device
80 Operation management unit
82 Operation management server
EV Electric vehicle (Power supply target)

What is claimed is:

1. A power supply system comprising:
a flying body including:
a propeller;
a propeller driving motor to drive the propeller;
a power control circuit to supply electric power to the propeller driving motor;
a battery to store the electric power;
a power generator to generate the electric power;
an engine to drive the power generator;
a fuel tank to store fuel to be supplied to the engine; and
a power suppling device to supply the electric power generated by the power generator to a power supply target to be supplied with the electric power;
a control unit to control various operations of the flying body; and
an operation management unit to manage flight operations of the flying body,
the operation management unit being configured to fly the flying body to a location of the power supply target upon receipt of a request for power supply, and
the control unit being configured to, after the flying body arrives at the location, generate the electric power by the power generator and supply the generated electric power to the power supply target via the power suppling device based on a command from the operation management unit.

2. The power supply system using a flying body according to claim 1, wherein the flying body is configured to supply the electric power to the power supply target while the flying body is flying.

3. The power supply system using a flying body according to claim 1, wherein the flying body is configured to supply the electric power to the power supply target while setting aside an amount of electric power that allows the flying body to fly to a predetermined return position.

4. The power supply system using a flying body according to claim 2, wherein the flying body is configured to supply the electric power to the power supply target while setting aside an amount of electric power that allows the flying body to fly to a predetermined return position.

5. The power supply system using a flying body according to claim 1, wherein the power supply request is received by an operation management server in the operation management unit via the internet.

6. The power supply system using a flying body according to claim 2, wherein the power supply request is received by an operation management server in the operation management unit via the internet.

7. The power supply system using a flying body according to claim 1, wherein
the power suppling device is configured to calculate a required amount of electric power for the power supply target, and if it is determined that the power suppling device is unable to supply electric power until the required amount of electric power is reached, it transmits a request for supplement to the operation management unit, and
upon receipt of the supplement request, the operation management unit flies as many flying bodies as needed to supply electric power to reach the required amount of electric power to the location of the power supply target.

8. The power supply system using a flying body according to claim 2, wherein
the power suppling device is configured to calculate a required amount of electric power for the power supply target, and if it is determined that the power suppling device is unable to supply electric power until the required amount of electric power is reached, it transmits a request for supplement to the operation management unit, and
upon receipt of the supplement request, the operation management unit flies as many flying bodies as needed to supply electric power to reach the required amount of electric power to the location of the power supply target.
